(19) United States
(12) Patent Application Publication
(10) Pub. No.: US 2026/0318229 A1
(43) Pub. Date: Oct. 15, 2026

(54) COMBINED HEAT AND POWER SYSTEM AND DATA CENTER

(71) Applicant: Mitsubishi Power Americas, Inc., Lake Mary, FL (US)

(72) Inventors: Peter Sawicki, Lake Mary, FL (US); Benjamin Wolfe, Lake Mary, FL (US); Song Wu, Livingston, NJ (US); Shimin Deng, Oakville (CA)

(21) Appl. No.: 19/634,555

(22) Filed: Mar. 31, 2026

Related U.S. Application Data
(60) Provisional application No. 63/780,745, filed on Mar. 31, 2025.

(51) Int. Cl. F01K 17/02; F02C 6/18; F02C 7/04; F22B 1/18; F24D 18/00; F24F 5/00; F24F 130/10; G06F 1/20

(52) U.S. Cl. CPC F01K 17/025; F02C 6/18; F02C 7/04; F22B 1/1815; F24D 18/00; F24F 5/0014; G06F 1/20; F05D 2220/72; F05D 2220/76; F24D 2200/26; F24F 2130/10; F24F 2203/026

(57) ABSTRACT

A power production facility includes a gas turbine engine configured to combust air and fuel to produce exhaust, an electrical generator driven by the gas turbine engine, and an absorption chiller configured to receive heat input generated by the gas turbine engine to generate chilled fluid. The facility can include an inlet air chiller for cooling inlet air to the gas turbine engine, improving efficiency. Thereafter, a data center receives the chilled fluid from the absorption chiller via the inlet air chiller. The heat input comprises exhaust gas directly or steam generated by the exhaust gas in a steam generator. The facility operates in different modes based on weather conditions, selectively routing hot water and/or steam and chilled fluid to optimize efficiency. The system provides multiple benefits including efficient use of waste heat, operational flexibility, and multiple revenue streams through simultaneous generation of electricity, chilled water, and hot water/steam.

### PRIORITY APPLICATIONS

This application claims the benefit of priority to U.S. Provisional Patent Application Ser. No. 63/780,745, Mar. 31, 2025, the content of which is incorporated herein by reference in its entirety.

### TECHNICAL FIELD

This document pertains generally, but not by way of limitation, to gas turbine power plants that can operate in conjunction with other systems, such as steam systems and cooling systems. More specifically, but not by way of limitation, the present application relates to systems and methods for using heat generated by a gas turbine engine as an input for an external heating and cooling system.

### BACKGROUND

In a gas turbine power plant, a gas turbine engine can be operated to directly generate electricity with a generator using shaft power. Compressed air and fuel can be combusted to produce exhaust gas to rotate a turbine of the gas turbine engine. The turbine can be used to drive a compressor to produce the compressed air and an electrical generator to produce electricity.

In simple cycle operation of a gas turbine engine power plant, the exhaust gas is typically vented to the atmosphere, sometimes with the use of systems for removing various emissions. Gas turbine operation can be combined with a steam system. The steam system can be used to generate steam that can be used to drive a steam turbine that can be used to generate electricity. Steam systems for combined-cycle power plants (also known as a GTCC) can typically comprise a heat recovery steam generator (HRSG) operating a Rankine cycle in combination with the Brayton cycle. Working fluid for the GTCC typically comprises air and/or gas (topping/Brayton cycle) and steam and/or water (bottoming/Rankine cycle) and a gas or liquid fuel is burned in the gas turbine engine. The air and/or gas of the topping cycle and the steam and/or water of the bottoming cycle can be integrated into other systems.

### OVERVIEW

The present inventors have recognized, among other things, that problems to be solved in the operation of gas turbine engines include the excess production of heat. Attempts have been made to utilize excess heat production of gas turbine engines via the use of the bottoming cycle to capture exhaust gas waste heat and generate steam. However, such steam generation plants are typically used to provide steam to drive a steam turbine, or provide heat to external sources, such as commercial or industrial processes. The present inventors have recognized that excess heat generated by gas turbine engines can also be used to produce cooling. In particular, the present inventors have recognized that heat from a gas turbine system can be used to generate cooled fluid with the use of one or more absorption chillers. The heat input into the absorption chiller can comprise one or both of the exhaust gas from a gas turbine engine or steam/water from a steam plant. Thus, both simple cycle and combined cycle gas turbine systems can be used with the absorption chiller. The cooled fluid generated by the absorption chiller can be used to perform one or both of A) cooling of inlet air to the gas turbine engine to increase the air density and output and B) provide cooling to an external heat generator, such as a data center. Furthermore, heat from the steam generator can be provided to other locations, such as community heat users, depending on operating conditions and weather conditions, e.g., environmental temperatures.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 is a schematic diagram of a combined heat and power system with an absorption chiller for data center cooling.

FIG. 2 is a schematic diagram of a combined heat and power system comprising a gas turbine engine operating in conjunction with a steam or hot water system and an absorption chiller to provide cooling to a data center.

FIG. 3 is a schematic diagram of the system of FIG. 2 operating in hot ambient weather conditions.

FIG. 4 is a schematic diagram of the system of FIG. 2 operating in cold ambient weather conditions.

FIG. 5 is a schematic diagram of the system of FIG. 2 operating in mild ambient weather conditions.

FIG. 6 is a schematic diagram of the system of FIG. 2 operating with a hot/cold energy export system.

FIG. 7 is a schematic diagram of the gas turbine engine and steam system of FIG. 2 showing details of the steam system.

FIG. 8 is a schematic illustration of a combined cycle power plant of the present disclosure comprising a gas turbine engine, a steam generator, a steam turbine, an absorption chiller, and a heat exchanger.

FIG. 9 is a schematic diagram of a combined cycle power plant comprising a gas turbine engine, a steam generator, a steam turbine, an absorption chiller, and a condenser, wherein at least a portion of the exhaust gas of the gas turbine engine can be routed through the absorption chiller.

FIG. 10 is a schematic diagram of a combined cycle power plant comprising a gas turbine engine, a steam generator, a steam turbine, an absorption chiller, and a condenser, wherein steam extraction from the steam turbine can be routed through the absorption chiller.

FIG. 11 is a schematic diagram of a combined cycle power plant comprising a gas turbine engine, a steam generator, a steam turbine, an absorption chiller, and a condenser, wherein at least a portion of the main steam of the steam generator can be routed through the absorption chiller.

FIG. 12 is a schematic diagram of a combined cycle power plant comprising a gas turbine engine operating in simple cycle with an absorption chiller, wherein at least a portion of the exhaust gas of the gas turbine engine can be routed through the absorption chiller.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

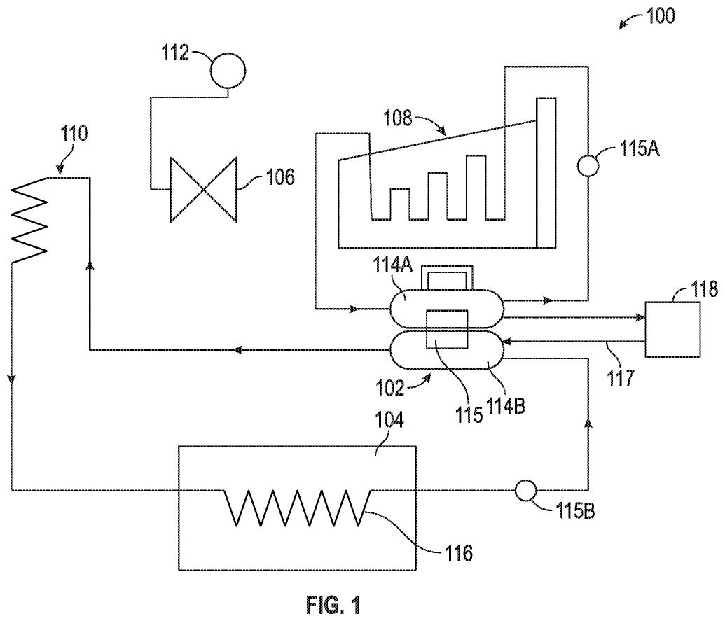

FIG. 1 is a schematic diagram of a combined heat and power system, e.g., system 100, with absorption chiller 102 for cooling data center 104. System 100 can additionally comprise a gas turbine engine (GTE), such as GTE 106, with inlet chilling cooler 110 and a heat recovery unit, e.g., HRU 108.

GTE 106 can be configured to generate hot exhaust gas via a combustion process in a conventional manner. For example, GTE 106 can include a compressor to generate compressed air that can be mixed with a fuel and combusted in a combustor to generate the exhaust gas. The exhaust gas can be used to drive a turbine that powers the compressor as well as to drive electrical generator 112. Electrical generator 112 can generate electrical power that can be sent to data center 104, or another consumer of a grid system.

Exhaust gas from GTE 106 can be passed into HRU 108. HRU 108 can produce hot water and/or steam that can be sent to absorption chiller 102. Absorption chiller 102 can be used to generate chilled water. Absorption chiller 102 can be used to convert heat from steam or hot water to boil a refrigerant or water into vapor, which can then be used to cool and condense. In examples, absorption chiller 102 can produce cold water through an evaporation, absorption, generation, and condensation cycle.

Hot water and/or steam from HRU 108 can pass into first portion 114A of the absorption chiller 102, e.g., a condenser-generator. Hot water and/or steam from HRU 108 can be circulated through first portion 114A via one or more pumps, such as pump 115A. Chilled water from second portion 114B of the absorption chiller 102 can be circulated through inlet chilling cooler 110 and data center 104 via one or more pumps, such as pump 115B. Second portion 114B can comprise an evaporator-absorber.

Chilled water from second portion 114B can be provided to inlet chilling cooler 110 and data center 104, where the chilled water is heated. Inlet chilling cooler 110 can be used to cool air entering the compressor of GTE 106, which can increase the efficiency and output of GTE 106. After passing through inlet chilling cooler 110, the cold water can pass into data center 104. In particular, the cold water can enter coils 116 to provide cooling to components of data center 104. In examples, cold water in coils 116 can be part of a heat exchanger and can be in thermal communication with cooling fluid circuits of data center 104 or coils 116, or can be placed directly into thermal contact with data center 104 components. Water that has been warmed by inlet chilling cooler 110 and data center 104 can be returned to second portion 114B of absorption chiller 102. Water cooled or steam cooled and condensed in first portion 114A of absorption chiller 102 can be returned to HRU 108 for heating. Various valves can be included in system 100 to control the flow of fluids through any of the disclosed components, such as to alternately flow chilled water through inlet chilling cooler 110 and data center 104.

First portion 114A can receive hot steam from HRU 108. The hot steam can impart heat to loop 115 in first portion 114A, thereby heating a working fluid water solution and therefore causing the water to evaporate. The temperature of the hot steam in first portion 114A can be lowered, thereby converting the steam to water in a condensing process. The evaporated working water from loop 115 can be condensed within first portion 114A via interaction with cooling water from cooling loop 117, which can be in communication with heat exchanger 118 that can, in examples, comprise a cooling tower. The working fluid is then directed into second portion 114B, where the working fluid water can evaporate at a very low pressure vacuum condition. The heat of evaporation for the working fluid water is taken from water flowing between coils 116 and inlet chilling cooler 110, thus producing chilled water. The evaporated working water can be absorbed back into the working fluid and cooled in second portion 114B of absorption chiller 102 via interaction with the cooling water from cooling loop 117. The diluted working fluid solution in second portion 114B of absorption chiller 102 can return to interaction with steam flowing between the outlet and inlet of HRU 108 and in second portion 114B of absorption chiller 102 to be heated and evaporated again, such as via a pumping action from a pump. Thus, the collected working fluid in second portion 114B can be pumped back to first portion 114A where the process can begin again.

With the present disclosure, a gas turbine combined heat and power (CHP) system, e.g., system 100, can provide electricity and cooling to data center 104 or another industry setting that needs both electricity and cooling.

Heat energy is converted from GTE 106 of a gas turbine (GT) plant to hot water, saturated steam, or superheated steam generated in HRU 108 with the exhaust gas. This heat energy is used to drive absorption chiller 102 that generates chilled water. In examples, absorption chiller 102 can generate chilled water with temperatures as low as 40 °F (~4.4 °C).

This chilled water with the low temperature can be first introduced to the inlet of GTE 106 using inlet chilling cooler 110. This low-temperature chilled water provides an adequate approach temperature to effectively cool GT inlet air to reduce the air temperature and increase air density. The reduced inlet air temperature and increased density enable GTE 106 to operate with significantly higher power output and higher efficiency. Increased GT power output is particularly desirable and economical in hot weather conditions.

The chilled water after passing through the GT air inlet is still sufficiently cold so that it can be used subsequently to provide cooling for data center 104. This chilled water can be used in data rooms that are air-cooled, liquid-cooled, or using combinations of air and liquid-cooled systems, including systems with direct-to-chip cooling plates or immersion cooling.

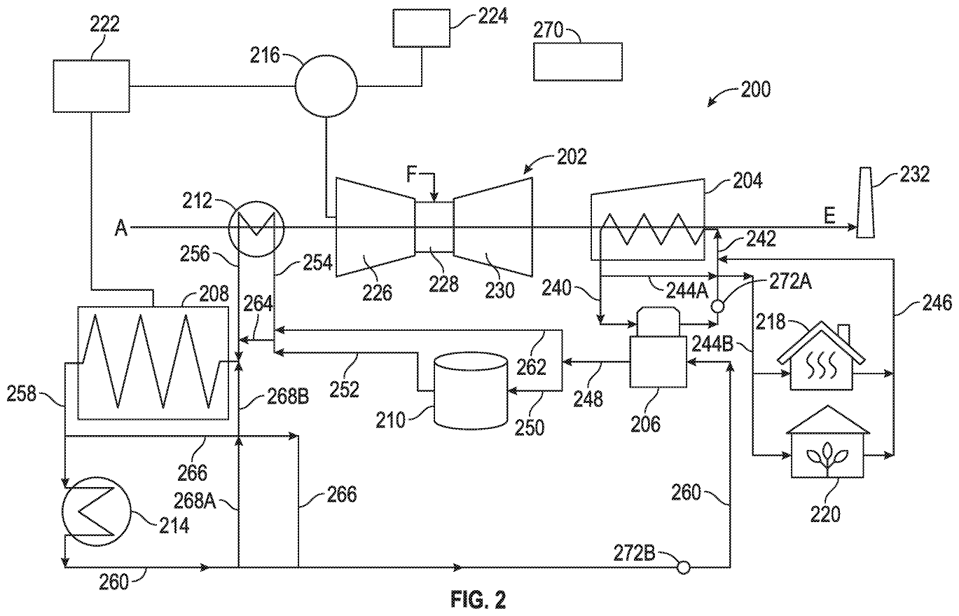

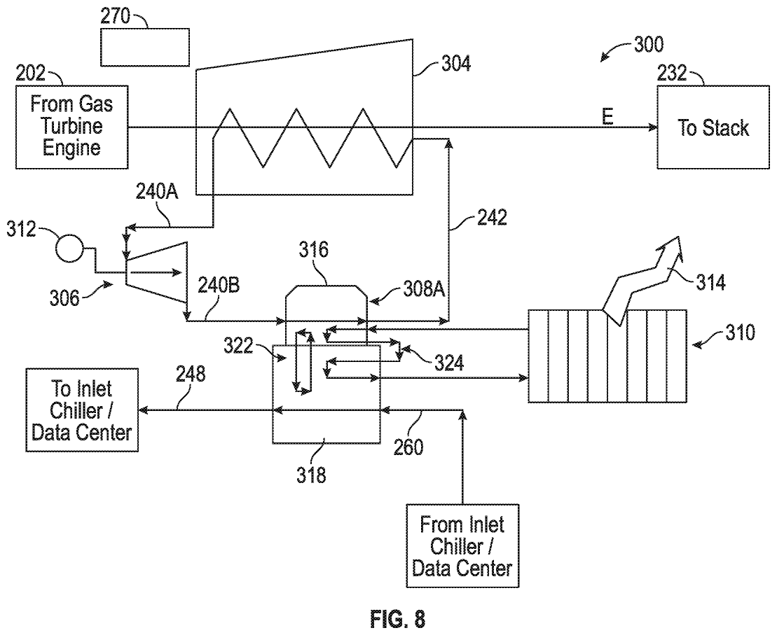

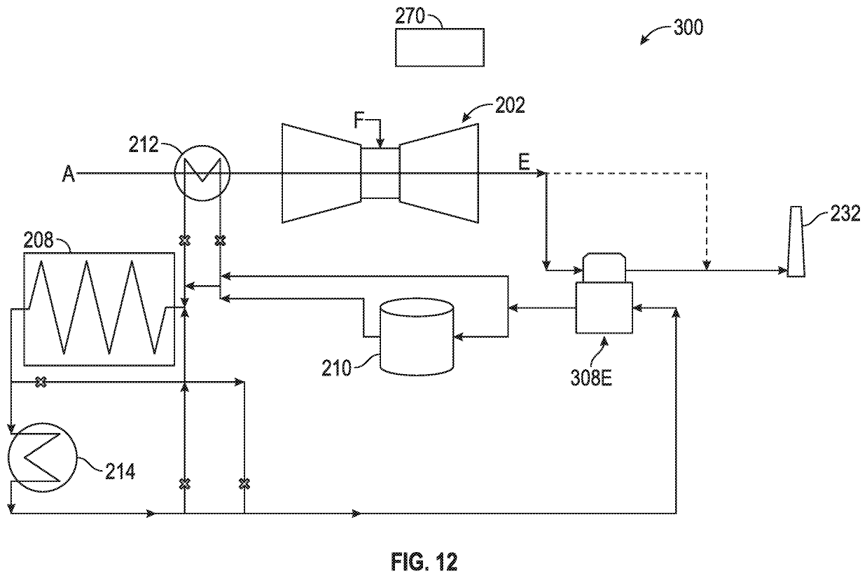

FIG. 1 shows GTE 106 operating in simple cycle with HRU 108 being used exclusively for driving absorption chiller 102. However, as discussed with reference to FIG. 2 through FIG. 7, HRU 108 can be used to provide heat to other consumers, such as residential heat consumers, industrial heat consumers, commercial heat consumers, and the like. Additionally, system 100 can be configured as a combined cycle power plant such that HRU 108 can be configured to drive a steam turbine that is configured to drive an electrical generator, as discussed with reference to FIG. 8 through FIG. 12. Furthermore, system 100 can be configured to operate without HRU 108, such that heat from the gas turbine engine is provided directly to absorption chiller 102, as shown in FIG. 12.

FIG. 2 is a schematic diagram illustrating system 200 comprising a gas turbine engine, e.g., GTE 202, a Heat Recovery Unit (HRU), e.g., HRU 204, absorption chiller 206, and data center cooling unit 208. System 200 can additionally include storage 210, inlet chilling cooler 212, and ambient cooling unit 214. GTE 202 can be used in conjunction with electrical generator 216. Additionally, system 200 can be connected to heat consumers, such as residential buildings 218 and greenhouse 220.

GTE 202 and electrical generator 216 can be configured to provide electrical power to data center 222 connected to data center cooling unit 208. Electrical generator 216 can also be used to provide electrical power to distributed grid network 224. GTE 202 can include compressor 226, combustor 228, and turbine 230. HRU 204 can be used in conjunction with other steam and water components, such as condensers, evaporators, coolers, pumps, valves, and the like. Pump 272A can be included on outlet line 242, and pump 272B can be included on line 260.

Ambient air A can enter compressor 226 through inlet chilling cooler 212. The compressed air is fed to combustor 228 and mixed with fuel F from a fuel source, which can be a source of natural gas, re-gasified LNG, or hydrogen (H2) gas, such as hydrogen from an electrolyzer, or liquid fuels. The compressed air from compressor 226 is mixed with the fuel for combustion in combustor 228 to produce high-energy gas for rotating turbine 230. Rotation of turbine 230 is used to produce rotational shaft power to drive compressor 226 and electrical generator 216. Exhaust gas E is directed to HRU 204, where exhaust gas E interacts with the appropriate water/steam piping of heat exchangers to produce steam. HRU 204 can additionally include appropriate means for conditioning exhaust gas E to remove or lower concentrations of specific emissions from exhaust gas E. For example, HRU 204 can include systems and devices for removing or lowering emissions from exhaust gas E, such as Selective Catalytic Reduction (SCR) emissions reduction units. As such, HRU 204 can include various emissions reduction units. Exhaust gas E can exit HRU 204 utilizing any appropriate venting means, such as stack 232.

Steam and/or hot water that is produced in HRU 204 can be used as an input to community heat users, such as residential buildings 218 and greenhouse 220. Additionally, other heat consumers, such as industrial and commercial consumers, can use heat from HRU 204. Additionally, absorption chiller 206 can receive hot water and/or steam from HRU 204. Absorption chiller 206 can utilize heat from HRU 204 to produce an outflow of chilled water that can be conveyed to one or both of inlet chilling cooler 212 and data center cooling unit 208. In examples, absorption chiller 206 can comprise a single-effect absorption chiller, or a double-effect absorption chiller. Storage 210 can be used to store chilled water and, in examples, can comprise a storage tank, with or without insulation.

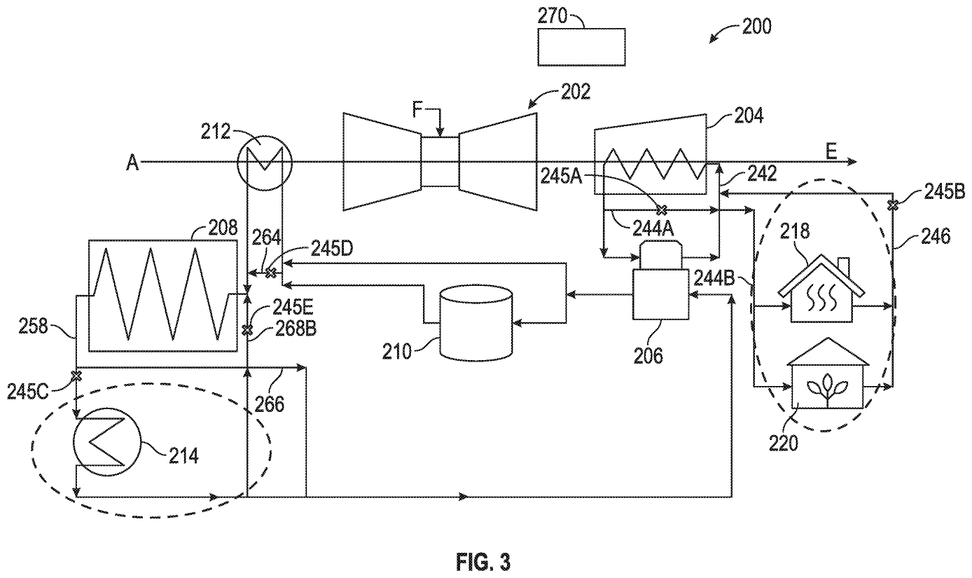

The CHP system, e.g., system 200, is configured to achieve energy efficiency and economical operation in all weather conditions, as discussed with reference to FIG. 3 through FIG. 5.

A gas turbine engine, e.g., GTE 202, can combust fuel to generate electricity and heat energy in the form of exhaust gas.

A heat recovery unit, e.g., HRU 204, can absorb the heat energy from the GT exhaust gas to generate hot water or steam. In the process, in examples, the exhaust gas temperature can be cooled from an inlet temperature of in the range of about 800 °F (~426 °C) to about 1,200 °F (~649 °C) to an outlet temperature of about 200 °F (~93.3 °C). For use in absorption chiller 206, the hot water and steam can be generally at mildly elevated pressures above the ambient pressure (up to about 150 psig [~10.3 Bar]). The steam can be saturated or superheated. In examples, the temperature of the hot water or steam for use in absorption chiller 206 can be in the range of about 180 °F (~82.2 °C) up to 450 °F (~232.2 °C). In additional examples, the upper range of the steam temperature can be higher. Temperatures and pressures for a gas turbine combined cycle power plant can be much higher.

An absorption chiller, e.g., absorption chiller 206, can use the energy in hot water or steam to generate chilled water. The chiller water supply temperature can be generally 40 °F (~4.4 °C) or higher. Absorption chiller 206 can be configured similarly to absorption chiller 102 of FIG. 1 and can operate in conjunction with a heat exchanger or cooling tower as described with reference to FIG. 1.

A thermal energy storage unit, e.g., storage 210, can store chilled water. The storage unit can take in chilled water when cooling duty demand is low for data center 222 and/or inlet chilling cooler 212 and, at a later time, discharge chilled water when cooling duty demand is high. For example, late nights, weekends, and the like can comprise periods of low cooling demand. The storage unit can widen the cooling operating range for both GT inlet chilling cooler 212 and data center cooling unit 208 in terms of cooling duty and response time. In examples, the storage unit can have the capacity to hold a rated chilled water supply from the absorption chiller sufficient to last approximately two hours to approximately forty-eight hours. Storage 210 can comprise a storage tank, which can be insulated to reduce heat gain from the surrounding environment and thereby preserve the temperature of the stored chilled water over time. In examples, storage 210 can comprise a stratified thermal storage tank in which chilled water occupies a lower stratum and warmer return water occupies an upper stratum, separated by a thermocline, thereby maintaining thermal stratification to improve storage efficiency. In other examples, storage 210 can comprise a pressurized vessel or a bank of interconnected tanks configured to provide a larger total storage volume. Storage 210 can comprise a simple mixed storage tank. Storage 210 can be connected to the cooling loop via line 248 on the inlet side and line 252 on the outlet side, and can be bypassed by line 262 connecting line 248 and line 254 when storage 210 is not in use or when direct flow to inlet chilling cooler 212 or data center cooling unit 208 is desired. Fill and discharge operations of storage 210 can be controlled by valves on line 248, line 252, and line 262, which can be operated by controller 270 based on cooling demand conditions, time-of-day scheduling, or pricing signals, as described herein.

A GT inlet air chilling unit, e.g., inlet chilling cooler 212, can cool the inlet air and increase its density, which will increase the mass flow and power output of GTE 202. Inlet chilling cooler 212 can reduce the air inlet temperature to as much as approximately 40 °F (~4.4 °C) to approximately 50 °F (~10 °C), depending on ambient conditions.

A data center cooling unit, e.g., data center cooling unit 208, can remove the heat generated from information technology (IT) equipment, wiring, and other building equipment of data center 222, using the supplied chilled water. The chilled water can be used in air-cooled systems, liquid-cooled systems, or combinations of air and liquid-cooled systems, including systems with direct-to-chip cooling plates or immersion cooling. In examples, modern data centers typically maintain the data room temperature between about 64 °F (~17.8 °C) to about 81 °F (~27.2 °C). In examples, a chilled water supply temperature of about 44 °F (~6.7 °C) to about 54 °F (~12.2 °C) can be sufficient to provide adequate cooling for most existing and new data centers, including the latest data center designs with advanced liquid cooling methods, such as direct-to-chip cooling and immersion cooling.

Data center cooling unit 208 can comprise one or more heat exchangers configured to transfer heat from data center 222 to the chilled water supplied from absorption chiller 206. In examples, data center cooling unit 208 can comprise a primary chilled water loop that circulates chilled water received from absorption chiller 206 through one or more cooling coils, heat exchanger panels, or manifold assemblies disposed within or adjacent to data center 222. In air-cooled configurations, data center cooling unit 208 can comprise one or more air handling units (AHUs) or computer room air handlers (CRAHs) in which chilled water flows through coils over which data center air is circulated by fans, thereby transferring heat from the air to the chilled water. In liquid-cooled configurations, data center cooling unit 208 can comprise a secondary distribution loop that delivers chilled water or a secondary coolant to liquid cooling elements disposed at or near individual IT equipment racks, including direct-to-chip cooling plates that are placed in thermal contact with processors or other heat-generating components, or immersion cooling baths in which IT equipment is submerged in a dielectric fluid that is in thermal communication with the chilled water loop. In examples combining air and liquid cooling, data center cooling unit 208 can comprise both AHUs or CRAHs and rack-level liquid cooling elements operating in parallel or in series within the chilled water distribution loop. Data center cooling unit 208 can be connected to the chilled water loop of system 200 via supply and return lines, such that chilled water enters data center cooling unit 208 from absorption chiller 206 or storage 210 via inlet chilling cooler 212, absorbs heat from data center 222, and returns as warmed water to absorption chiller 206 or ambient cooling unit 214 for heat rejection. One or more pumps, valves, and flow control devices can be included within or associated with data center cooling unit 208 to regulate the flow rate and distribution of chilled water to the various cooling elements within data center 222, and these components can be operated by controller 270 as described herein.

In embodiments, it is beneficial to route the chilled water from the absorption chiller 206 to the inlet chilling cooler 212 before the data center cooling unit 208. The cooling requirements to decrease the inlet air temperature for the GTE 202 are more stringent than those to cool the data center 222. That is, the inventors have discovered a particularly advantageous arrangement in which the cooling needs of both the inlet chilling cooler 212 and data center cooling unit 208 can be met by placing the inlet chilling cooler 212 upstream of the data center cooling unit 208.

An ambient cooling unit, e.g., ambient cooling unit 214, can be used to cool down water that has been warmed and is exiting from the data center using relatively cooler ambient air. This cooling unit can offer free cooling in cold weather. Ambient cooling unit 214 can comprise a heat exchanger, such as a tube-fin heat exchanger where water can flow through tubes and fins extending from the tube can be used to dissipate heat to the atmosphere. Ambient cooling unit 214 can include one or more fans configured to force ambient air across the heat exchanger to increase the rate of heat dissipation, and can operate in either a forced-draft or induced-draft configuration. Ambient cooling unit 214 can be connected to the cooling loop via lines 258 and 260, and can be selectively bypassed via line 266 when ambient temperatures are too warm to provide useful cooling or when ambient cooling unit 214 is otherwise not in service, as described herein.

In cold weather conditions when there is low cooling demand for inlet chilling cooler 212 and data center cooling unit 208, the hot water and/or steam generated from HRU 204 can be directed to the community heat users, examples of which can include residential heating, industrial heat, greenhouses, swimming pool heating, etc., including residential buildings 218 and greenhouse 220.

Flow of fluids through various components and/or sub-systems of system 200 can be controlled using appropriate flow lines and valving. In particular, flow can be controlled in different ambient operating conditions, e.g., different temperature conditions, to improve efficiency in operation of system 200 or to otherwise affect the performance of system 200 in advantageous ways. Controller 270 can be connected to automatically adjust flows for overall system operation and optimization, e.g., by using electrically operated, controllable valves placed on any of the fluid flow lines described herein. Controller 270 can communicate with system components, e.g., valves (e.g., valve 245A through valve 245O) and pumps (e.g., pump 272A and pump 272B), via any suitable wired or wireless connection. Controller 270 can comprise one or more processors and a non-transitory, computer-readable storage medium storing instructions executable by the one or more processors. The storage medium can store instructions for operating the valves and pumps based on different weather and/or temperature conditions, such as by including look-up tables having valve states for various temperatures.

Controller 270 can receive inputs from one or more sensors disposed throughout system 200, including temperature sensors configured to measure ambient air temperature, inlet air temperature at compressor 226, exhaust gas temperature at HRU 204, and chilled water temperature at the outlet of absorption chiller 206, as well as flow sensors and pressure sensors disposed on one or more of the fluid flow lines described herein. Based on the sensor inputs, controller 270 can determine an operating mode for system 200, such as a hot weather operating mode, a cold weather operating mode, or a mild weather operating mode, as described with reference to FIG. 3 through FIG. 5, and can generate control signals to position valves 245A through 245O and operate pumps 272A and 272B in accordance with the determined operating mode. Controller 270 can additionally receive external inputs, such as signals from a grid energy management system, electricity pricing signals, or user-defined set points, to further adjust system operation. In examples, controller 270 can operate in a closed-loop feedback manner, continuously monitoring sensor outputs and adjusting valve positions and pump operation to maintain target temperatures and flow rates within system 200. Controller 270 can also be configured to store historical operating data and to log system performance parameters for diagnostic and optimization purposes.

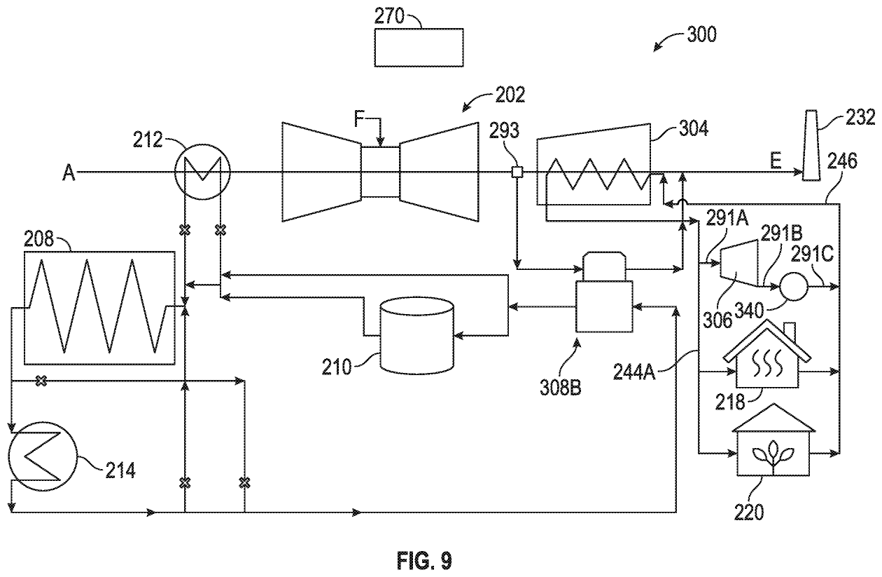

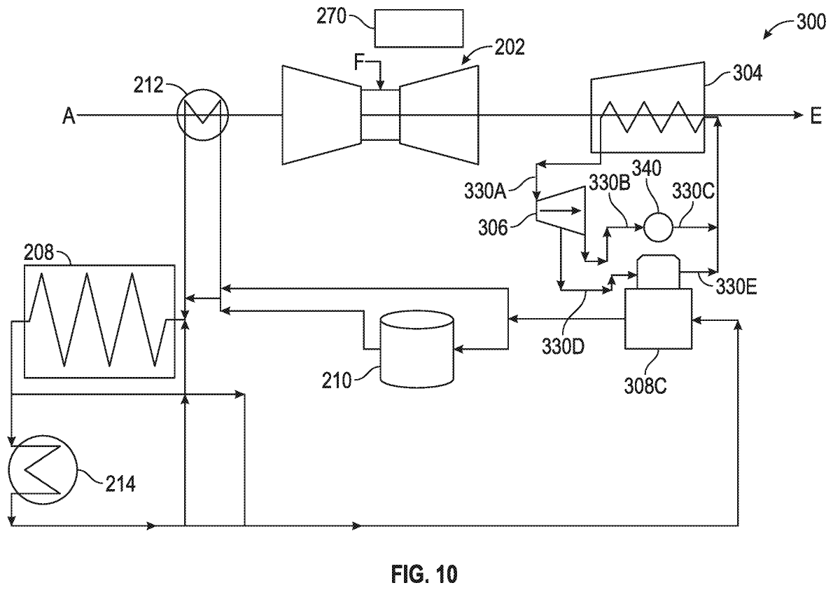

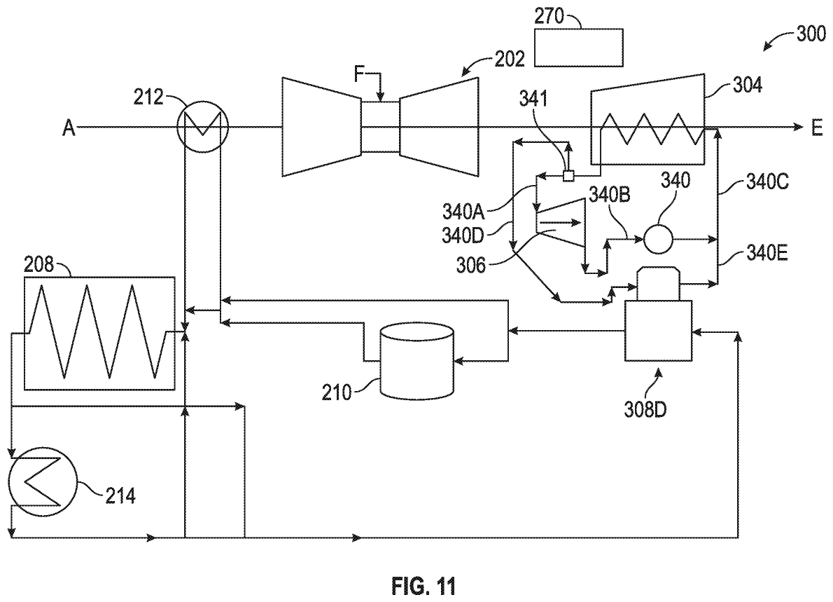

Controller 270, or a controller configured similarly to controller 270, can be used to control and operate any of the systems described herein, including the systems depicted in FIG. 1 through FIG. 12. For example, in the combined cycle embodiments of FIG. 8 through FIG. 11, a controller can be configured to control steam turbine 306, condenser 340, and one or more absorption chillers 308A through 308D, as well as the associated valves and pumps of those systems, in a manner consistent with the control functions described above for controller 270. In the embodiment of FIG. 9, a controller can additionally be configured to operate exhaust gas diverter 293 to control the proportion of exhaust gas from GTE 202 directed to HRU 304 versus absorption chiller 308B, based on sensor inputs and operating mode determinations. In the embodiments of FIG. 10 and FIG. 11, a controller can be configured to control the proportion of steam directed to absorption chillers 308C and 308D, respectively, relative to the proportion directed to steam turbine 306, such as by operating one or more actively controlled valves on the steam lines connecting HRU 304, steam turbine 306, and the respective absorption chiller. In the simple cycle embodiment of FIG. 12, a controller can be configured to control the flow of exhaust gas from GTE 202 to absorption chiller 308E and to manage the chilled fluid output of absorption chiller 308E for delivery to one or both of inlet chilling cooler 212 and data center cooling unit 208. In any embodiment, the controller can receive inputs from sensors measuring temperatures, pressures, and flow rates at relevant points in the system, and can generate control signals to operate valves, pumps, and other actuated components to achieve a target operating mode or to optimize system performance based on demand, pricing signals, and weather conditions.

HRU 204 can be connected to absorption chiller 206 via inlet line 240 and outlet line 242. Inlet line 240 can be connected to community heat users by line 244A and line 244B, and community heat users can be connected to HRU 204 via line 246. Absorption chiller 206 can be connected to a cooling loop that can comprise line 248, line 250, line 252, line 254, line 256, line 258, and line 260. Storage 210 can be bypassed by line 262 that connects line 248 and line 254. Inlet chilling cooler 212 can be bypassed by line 264 that connects line 254 and line 256.

Ambient cooling unit 214 can be bypassed by line 266 that connects line 258 and line 260, and line 268A and line 268B that connect line 260 to the data center cooling unit 208. Each of these lines can include a valve to control flow of fluid therethrough.

FIG. 3 is a schematic diagram of system 200 of FIG. 2 operating in hot ambient weather conditions. Elements in FIG. 3 that are the same as FIG. 2 and not labeled shall have the same reference numeral(s) as in FIG. 2. During hot ambient weather conditions, (i) valve 245A in line 244A, (ii) valve 245B in line 246, (iii) valve 245C in line 258 downstream of line 266, (iv) valve 245D in line 264, and (v) valve 245E in line 268B can be closed. As such, community heat users can be prevented from receiving hot steam. Thus, hot steam or water from HRU 204 can be routed completely or nearly completely through absorption chiller 206 via inlet line 240 and outlet line 242. Additionally, ambient cooling unit 214 can be prevented from receiving water from absorption chiller 206. Thus, water from data center cooling unit 208 can flow from line 258, through line 266 and into line 260 for flowing back to absorption chiller 206.

In examples of hot weather conditions (e.g., about 85 °F (~29.4 °C) or higher), all or nearly all recovered waste heat (e.g., hot water/steam) is directed to absorption chiller 206. The produced chilled water is sent first to inlet chilling cooler 212. The chilled water is then used for data center cooling at data center cooling unit 208. The chilled water storage unit, e.g., storage 210, can be charged and discharged as needed to balance the combined cooling duty demand of inlet chilling cooler 212 and data center cooling unit 208 against the production rate of absorption chiller 206. Ambient cooling unit 214 can be out of service, e.g., not in use, in such an operating state of system 200. Additionally, no heat is provided to community heat users in such an operating state of system 200.

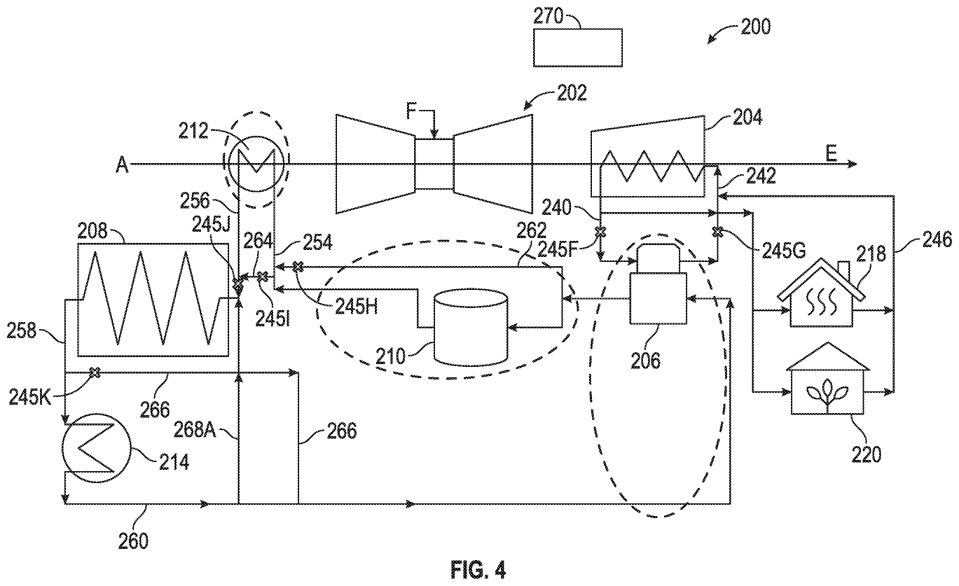

FIG. 4 is a schematic diagram of system 200 of FIG. 2 operating in cold ambient weather conditions. Elements in FIG. 4 that are the same as FIG. 2 and not labeled shall have the same reference numeral(s) as in FIG. 2. During cold weather ambient conditions, (i) valve 245F in inlet line 240 downstream of line 244A, (ii) valve 245G in outlet line 242 upstream of line 246, (iii) valve 245H in line 262, (iv) valve 245I in line 264, (v) valve 245J in line 256, and (vi) valve 245K in line 266 upstream of ambient cooling unit 214 can be closed. As such, absorption chiller 206 can be prevented from receiving hot steam or water from HRU 204. Thus, hot steam or water from HRU 204 can be routed completely or nearly completely through community heat users via line 244A, line 244B, and line 246. Additionally, storage 210 and inlet chilling cooler 212 can be prevented from receiving any or nearly all cold water from absorption chiller 206 or ambient cooling unit 214. Valves in line 262, line 264, line 254, and line 256 can be closed to isolate inlet chilling cooler 212 and storage 210. Thus, cold water from ambient cooling unit 214 can be circulated between data center cooling unit 208 via line 258, line 260, line 268A, and line 268B.

In examples of cold weather conditions (e.g., about 45 °F (~7.2 °C) or lower), the hot water/steam produced in HRU 204 can be directed to the community heat users, e.g., residential buildings 218 and greenhouse 220. Absorption chiller 206, chilled water storage, e.g., storage 210, and inlet chilling cooler 212 can be out of service, e.g., not in use. The cooling need for the data center is entirely met by ambient cooling unit 214.

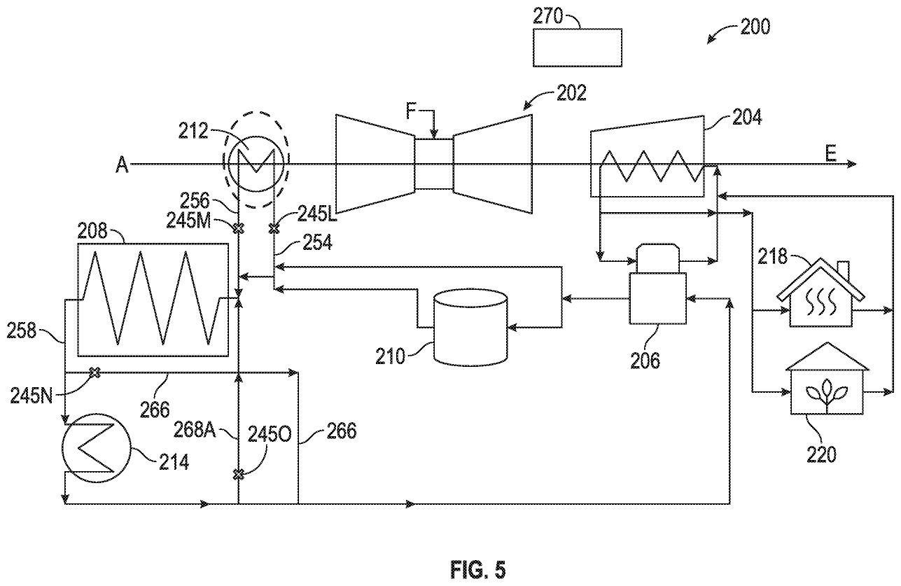

FIG. 5 is a schematic diagram of system 200 of FIG. 2 operating in mild ambient weather conditions. Elements in FIG. 5 that are the same as FIG. 2 and not labeled shall have the same reference numeral(s) as in FIG. 2. During mild weather ambient operating conditions, (i) valve 245L in line 254, (ii) valve 245M in line 256, (iii) valve 245N in line 266, and (iv) valve 2450 in line 268A can be closed. As such, inlet chilling cooler 212 can be prevented from receiving chilled water from absorption chiller 206. Thus, hot steam or water from HRU 204 can be routed through community heat users via line 244A, line 244B, and line 246, as well as absorption chiller 206 through inlet line 240 and outlet line 242. Also, chilled water from absorption chiller 206 can be circulated between data center cooling unit 208 and storage 210.

In examples of mild weather conditions (about 50 °F (~10.0 °C)-80 °F (~26.7 °C)), ambient cooling unit 214 can only support a portion of the data center cooling duty, with the balance being met by absorption chiller 206 operating at reduced load. A part of the hot water/steam can be sent to community heat users, for example, greenhouses and industry users. Inlet chilling cooler 212 can be generally out of service, e.g., not in use, except in special situations, such as when there is a power shortage or there are high electricity prices when boosting GT power output is desirable.

It should be noted that the above definitions of weather conditions are indicative and approximate. Temperature examples mentioned above are only one indication of weather conditions. Other parameters, such as humidity and wind speed, have a significant impact on the optimum operating mode under given conditions. Thus, system 200 can be operated in the various modes in temperature and weather conditions outside of the listed temperature ranges depending on the totality of the circumstances.

It should be noted that the operating modes described above are indicative to demonstrate the capability and flexibility of the disclosed GT CHP system. Actual operation of the system can account for the temperature set point for individual data centers, equipment conditions, economic factors/pricing signals, including electricity price and price for heat/chilled water supply, etc., in addition to weather conditions. An energy management system can be used to control and operate the CHP system, taking into account all such conditions. Thus, system 200 can be operated in other operating modes than explicitly described herein, depending on the specific equipment used in the combined cycle power plant and data center, for example.

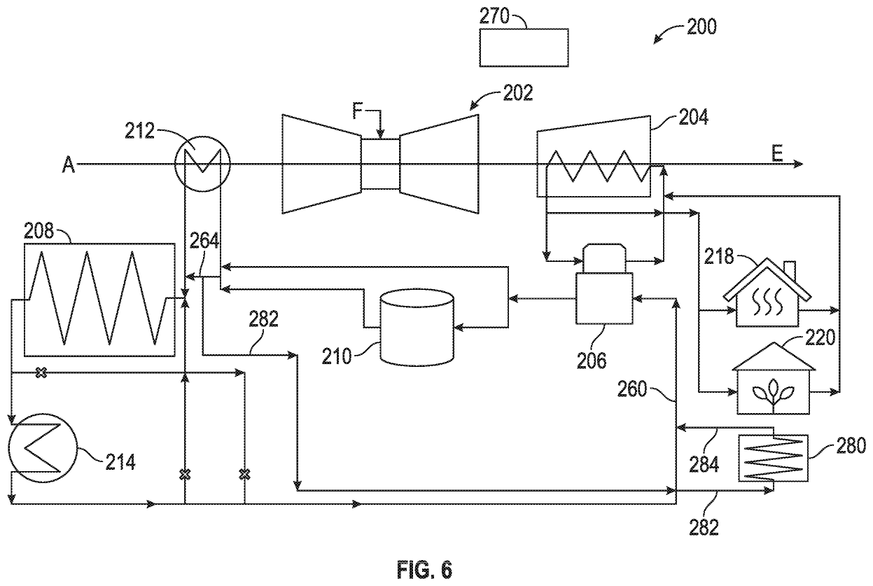

FIG. 6 is a schematic diagram of system 200 of FIG. 2 operating with a hot/cold energy export system. Elements in FIG. 6 that are the same as FIG. 2 and not labeled shall have the same reference numeral(s) as in FIG. 2. System 200 of FIG. 6 can include the same elements of system 200 of FIG. 2 with the addition of heat exchanger 280, line 282, and line 284. In particular, system 200 can include heat exchanger 280 that can be connected to the cooling loop using line 282 and line 284. Line 282 can connect an inlet of heat exchanger 280 with line 264. Line 284 can connect an outlet of heat exchanger 280 with line 260.

Data centers can have various cooling duties. In general, data centers are becoming more energy efficient and requiring less energy for cooling. When the recovered energy of system 200 exceeds the cooling needs of the data center and GT inlet cooling, a part of this energy can be exported in the form of chilled water to other users, such as space cooling provided by heat exchanger 280, or in the form of hot water/steam to the community heat users, e.g., residential buildings 218 and greenhouse 220. Flow of chilled water to heat exchanger 280 can be controlled by valves to selectively include or exclude flow of chilled water to heat exchanger 280, depending on weather conditions or conditions of data center cooling unit 208.

In addition to space cooling, chilled water from absorption chiller 206 can be provided to a range of other external chilled water users and applications. For example, chilled water can be supplied to industrial process cooling applications, such as cooling of manufacturing equipment, chemical processing facilities, or food and beverage production facilities that require temperature-controlled fluid streams. In other examples, chilled water can be provided to district cooling systems that distribute chilled water through an underground pipe network to multiple buildings or facilities within a campus, commercial district, or municipality, thereby serving as a centralized cooling resource for multiple end users simultaneously. Chilled water can additionally be supplied to agricultural applications, such as controlled-environment agriculture facilities or cold storage facilities for perishable goods. In further examples, chilled water can be provided to other data centers or server facilities located in proximity to system 200, or to telecommunications facilities that require cooling for electronic equipment. The chilled water can also be used in medical or laboratory facilities requiring temperature-controlled environments or process cooling. In each of these applications, the flow of chilled water to the respective external user can be controlled by one or more valves operated by controller 270, as described herein, to selectively include or exclude flow to each external user based on demand, weather conditions, pricing signals, or the cooling requirements of data center cooling unit 208 and inlet chilling cooler 212. The temperature of chilled water supplied to external users will generally be at or above the supply temperature of absorption chiller 206, which can be approximately 40 °F (~4.4 °C) or higher, and external users can be selected and configured based on their compatibility with this supply temperature range.

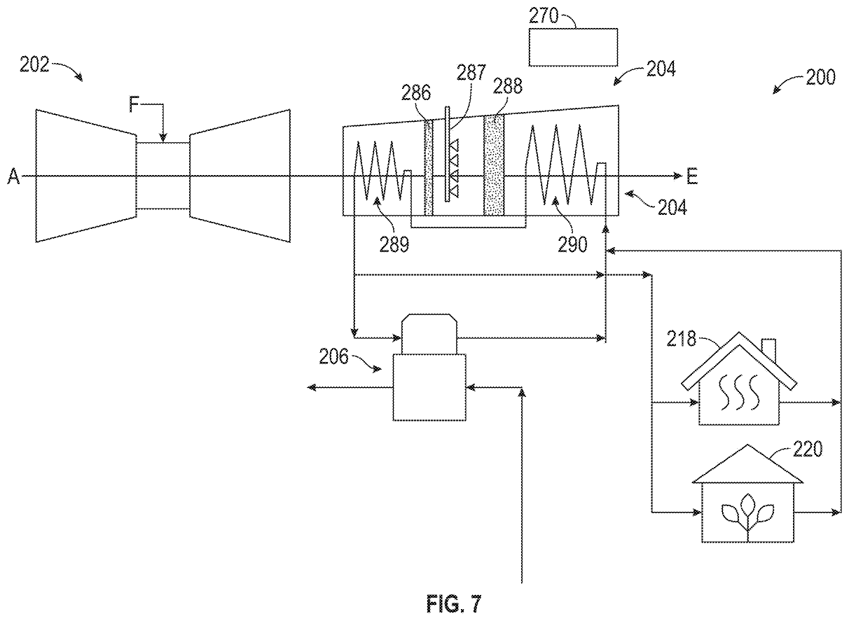

FIG. 7 is a schematic diagram of GTE 202 and HRU 204 of FIG. 1 showing details of the steam system. GTE 202 and absorption chiller 206 can operate as described herein. Carbon monoxide (CO) oxidation catalyst and selective catalytic reduction (SCR) catalyst are commonly required for emission control in GT plants. Thus, HRU 204 can be provided with CO catalyst panel 286, ammonia injection grid 287, and nitrogen oxides (NOx) catalyst 288. In the integrated heat recovery unit with CO and NOx emission controls, the GT exhaust first encounters the last stage(s) of the water/steam tube bundles, e.g., at coils 289, that cool the exhaust in the range of about 800 °F (~426.7 °C) to about 1200 °F (~649 °C) to in the range of about 600 °F (~315.6 °C) to about 800 °F (~426.7 °C). The CO catalyst, the ammonia injection grid, and the SCR catalyst are placed in the area within this reduced temperature range.

Downstream of the CO and NOx controls, the exhaust gas is further cooled by the first stage(s) of water/steam tube bundles, e.g., coils 290, for complete heat recovery. The produced hot water/steam can be used in absorption chillers and/or in community heat users as described previously.

### Example Benefits of the Present Disclosure

The GT CHP systems of the present disclosure, e.g., system 100 and system 200, can utilize heat recovered from the GT exhaust to drive the absorption chiller. Chilled water can first be used in GT inlet air chilling followed by data center cooling. This CHP configuration provides thermally efficient and cost-effective cooling for both GT inlet air and data center.

The CHP systems of the present disclosure can be configured with the flexibility to provide cooling and/or heating depending on weather conditions, thus maximizing equipment utilization year-round.

The chilled water storage unit, e.g., storage 210, can provide additional operation flexibility in meeting daily and weekly cooling demand fluctuations.

The ambient cooling unit, e.g., ambient cooling unit 214, can take advantage of free cooling by cold ambient air, further increasing the system energy efficiency and increasing opportunities to provide thermal energy (e.g., cooling and/or heating) for other applications.

The CHP systems of the present disclosure can easily accommodate state-of-the-art CO and NOx control equipment.

The CHP systems of the present disclosure can be highly energy efficient with a low carbon footprint. The systems can cool the GT exhaust to as low as 200 °F (~93.3 °C), which is close to the conducive temperature for adding a post-combustion carbon capture unit that can remove approximately 95% of the CO2 in the exhaust.

The CHP systems of the present disclosure can generate and supply electricity, chilled water, and hot water/steam simultaneously. This not only greatly improves year-round energy efficiency but also opens up opportunities for economical operation with multiple revenue streams.

The highly efficient combined heat and power systems of the present disclosure can potentially qualify for various federal, state, and local government energy incentives, including federal investment tax credits (ITC). For example, a plant with the proposed CHP system would be eligible as a Qualifying Facility (QF) under the Public Utility Regulatory Policies Act (PURPA) of 1978, which requires utilities to purchase the electricity generated by the QF at a “just and reasonable” rate.

The benefits of the combined heat and power plants of the present disclosure can be expanded with other configurations described herein, such as those described with reference to FIG. 8 through FIG. 12.

In another example of an alternative configuration of the combined heat and power systems of the present disclosure, all of the steam from a steam generator can be provided into a backpressure steam turbine, and the exhaust steam from the steam turbine can be used to drive one or more absorption chillers, as described with reference to FIG. 8.

FIG. 8 is a schematic illustration of a combined cycle power plant, e.g., system 300, of the present disclosure comprising a gas turbine engine, e.g., GTE 202, a steam generator or heat recovery unit, e.g., HRU 304, steam turbine 306, absorption chiller 308A, and heat exchanger 310, which can be connected to absorption chiller 308A via cooling loop 324. GTE 202 can be configured to drive electrical generator 216 (FIG. 1) and steam turbine 306 can be configured to drive electrical generator 312. GTE 202 can be operated in a conventional manner to generate hot exhaust gas to boil water within HRU 304. The steam generated in HRU 304 can be used to rotate steam turbine 306 via inlet line 240A and outlet line 240B. In the example of FIG. 8, steam from steam turbine 306 is directed to absorption chiller 308A. Absorption chiller 308A can comprise a single-effect absorption chiller, or a double-effect absorption chiller, or others. As discussed herein, absorption chiller 308A can be used to provide chilled water to storage 210 (FIG. 2), inlet chilling cooler 212 (FIG. 2), data center cooling unit 208 (FIG. 2), ambient cooling unit 214 (FIG. 2), and heat exchanger 280 (FIG. 6). FIG. 8 additionally shows heat loss 314 emanating from heat exchanger 310.

Absorption chiller 308A can comprise condenser-generator 316 and evaporator-absorber 318. Absorption chiller 308A can be configured similarly to absorption chiller 102 of FIG. 1 and can operate in conjunction with a heat exchanger or cooling tower as described with reference to FIG. 1.

Absorption chiller 308A can receive above-atmospheric pressure steam from steam turbine 306. All steam generated in HRU 304 can be first expanded in steam turbine 306 to a low pressure above ambient pressure. All the steam at this low pressure can be directed to absorption chiller 308A to produce chilled water. Heat exchanger 310 can comprise a cooling tower configured to cool heated water by heat exchange with ambient air. The cooling water within heat exchanger 310 can take on heat from loop 322 within absorption chiller 308A. Thus, heat exchanger 310 can generate heat loss 314 that is not used for the advantageous purposes of system 300.

In another example of an alternative configuration of the combined heat and power systems of the present disclosure, a part of the gas turbine exhaust can be used to drive one or more absorption chillers, as described with reference to FIG. 9.

FIG. 9 is a schematic diagram of a combined cycle power plant, e.g., system 300, comprising GTE 202, HRU 304, and absorption chiller 308B. In the example of FIG. 9, system 300 can additionally include condenser 340. In the arrangement of FIG. 9, at least a portion of exhaust gas E from GTE 202 can be routed into absorption chiller 308B. System 300 of FIG. 9 can include the same elements as system 200 of FIG. 2, with the addition of steam turbine 306 and condenser 340. In particular, line 291A, line 291B, and line 291C can be added between line 244B and line 246 to connect steam turbine 306 and condenser 340. Absorption chiller 308B can comprise a single-effect absorption chiller, a double-effect absorption chiller, or others. Where absorption chiller 308B receives exhaust gas directly from GTE 202, absorption chiller 308B can include a gas-side heat exchanger configured to transfer thermal energy from the exhaust gas stream to the working fluid of the absorption chiller in place of the steam or hot water input described with reference to absorption chiller 102 of FIG. 1. The gas-side heat exchanger can comprise a tube bundle or plate-fin heat exchanger configured for gas-to-liquid heat exchange at the temperatures and flow rates present in the exhaust gas stream of GTE 202, and the exhaust gas can exit absorption chiller 308B at a reduced temperature before being directed to stack 232 for venting.

A part of the exhaust of GTE 202 can be routed through HRU 304, and a part of the exhaust can be routed through absorption chiller 308B. An actively controlled exhaust gas diverter, e.g., diverter 293, can be installed between GTE 202 and HRU 304. Diverter 293 can comprise a door or flap positioned within an exhaust gas duct for GTE 202 that can be rotated, pivoted or otherwise moved to directed exhaust gas into HRU 304 or absorption chiller 308C.

Diverter 293 can be configured to direct anywhere from zero percent to one-hundred percent of the exhaust gas from GTE 202 to either of HRU 304 or absorption chiller 308C. Diverter 293 can be motorized with an electric motor and can be controlled with controller 270. Diverter 293 can be operated based on ambient temperatures. Absorption chiller 308B can be configured similarly to absorption chiller 102 of FIG. 1 and can operate in conjunction with a heat exchanger or cooling tower as described with reference to FIG. 1. Exhaust gas used in HRU 304 can be used to generate steam or hot water to be used for other purposes, such as power generation and community heat users. For power generation, steam is expanded in steam turbine 306 and then condensed in condenser 340 before it is returned to HRU 304. The proportion of GTE 202 exhaust gas used for the absorption chiller can be controlled based on demand and pricing of various cooling, heating, and electricity uses. Additionally, the proportion of exhaust gas split between the two can vary based on specific design configurations.

In additional examples of alternative configurations of the combined heat and power systems of the present disclosure, steam extraction from the steam turbine or steam from the steam generator circuit can be used to drive one or more absorption chillers, as described with reference to FIG. 10 and FIG. 11, respectively.

FIG. 10 is a schematic diagram of a combined cycle power plant, e.g., system 300, comprising GTE 202, HRU 304, absorption chiller 308C, steam turbine 306, and condenser 340, wherein extraction steam of steam turbine 306 can be routed through absorption chiller 308C. System 300 of FIG. 10 can include the same elements of system 200 of FIG. 2 with the addition of steam turbine 306 and condenser 340. In particular, line 330A, line 330B, and line 330C can be added to connect steam turbine 306 and condenser 340 to HRU 304. Line 330A can include main steam, line 330B can include extract steam, and line 330C can include exhaust steam. Additionally, line 330D and line 330E can be added to connect absorption chiller 308C to steam turbine 306 and HRU 304. Absorption chiller 308C can comprise a single-effect absorption chiller, a double-effect absorption chiller, or others. Absorption chiller 308C can be configured similarly to absorption chiller 102 of FIG. 1 and can operate in conjunction with a heat exchanger or cooling tower as described with reference to FIG. 1.

Steam from HRU 304 can be directed to steam turbine 306. Extraction steam from steam turbine 306 can be directed to absorption chiller 308C, and exhaust steam from steam turbine 306 can be directed to condenser 340. To maximize or otherwise improve the overall efficiency of system 300, it is desirable that the steam first expand in steam turbine 306 to an intermediate to low pressure, before being extracted/sent to absorption chiller 308C. The proportion of steam extraction for absorption chiller 308C can be controlled based on demand and pricing of various cooling, heating, and electricity uses. Steam in line 330D can be at low pressure and low temperature relative to HRU 304 but will be higher than steam in line 330B. In examples, steam from steam turbine 306 can be extracted from a low-pressure stage of steam turbine 306 for use with absorption chiller 308C. In examples, steam flow into line 330D can be actively controlled. Thus, if it were desirable to maximize or otherwise increase output of steam turbine 306 to increase electricity production, flow into line 330D can be shut off, and HRU 304 and steam turbine 306 can act as a combined cycle power plant. Thus, low-pressure and temperature steam in line 330B can be converted to liquid, e.g., water, at condenser 340. However, if it is desirable to provide cooling with absorption chiller 308C and maximum power production is not desired or needed, flow into line 330D can be permitted at higher temperature and pressure compared to line 330B to extract useful work with absorption chiller 308C.

FIG. 11 is a schematic diagram of a combined cycle power plant, e.g., system 300, comprising a GTE 202, HRU 304, absorption chiller 308D, steam turbine 306, and condenser 340, wherein at least a portion of the main steam of HRU 304 can be routed through absorption chiller 308D. System 300 of FIG. 11 can include the same elements of system 200 of FIG. 2 with the addition of steam turbine 306 and condenser 340. In particular, line 340A, line 340B, and line 340C can be added to connect steam turbine 306 and condenser 340 to HRU 304. Additionally, line 340D and line 340E can be added to connect absorption chiller 308D to HRU 304. Absorption chiller 308D can comprise a single-effect absorption chiller, a double-effect absorption chiller, or others. Absorption chiller 308D can be configured similarly to absorption chiller 102 of FIG. 1 and can operate in conjunction with a heat exchanger or cooling tower as described with reference to FIG. 1.

Steam from HRU 304 can be directed to steam turbine 306 and absorption chiller 308D. A part of the steam generated in HRU 304 is directed to steam turbine 306, and a portion of the steam generated in HRU 304 is directed to absorption chiller 308D. The splitting of steam between steam turbine 306 and absorption chiller 308D can be accomplished using valve 341 disposed on the steam line connecting HRU 304 to absorption chiller 308D. Valve 341 can comprise an actively controlled flow control valve, such as a modulating globe valve, a butterfly valve, or another valve type suitable for steam service at the pressures and temperatures present in the steam lines of system 300. Valve 341 can be positioned at or near the junction where the steam line from HRU 304 splits between the line directed to steam turbine 306 and the line directed to absorption chiller 308D, such that adjustment of valve 341 controls the proportion of steam flowing to absorption chiller 308D relative to the proportion flowing to steam turbine 306. In examples, valve 341 can be configured to modulate continuously between a fully open position, in which all or nearly all steam from HRU 304 is directed to absorption chiller 308D, and a fully closed position, in which no steam is directed to absorption chiller 308D and all steam is directed to steam turbine 306. In other examples, valve 341 can be operated in discrete positions corresponding to predetermined steam split ratios selected based on system operating conditions. The proportion of steam extraction for absorption chiller 308D and steam turbine 306 can be controlled by valve 341 based on demand and pricing of various cooling, heating, and electricity uses. For example, when cooling demand from data center cooling unit 208 or inlet chilling cooler 212 is elevated, valve 341 can be opened to a greater degree to direct more steam to absorption chiller 308D to increase chilled water production. Conversely, when electricity production is the priority, valve 341 can be closed or partially closed to direct more steam to steam turbine 306. Valve 341 can be operated by controller 270, or a controller configured similarly to controller 270 as described herein, based on sensor inputs including steam pressure and temperature at HRU 304, steam flow rates in the respective lines, and cooling and electricity demand signals. In examples, steam in line 340D can be high-pressure and high-temperature main steam, and steam in line 340B can be low-pressure and low-temperature exhaust steam.

In another example of an alternative configuration of the combined heat and power systems of the present disclosure, all of the exhaust of a gas turbine engine can be used to drive one or more absorption chillers, as described with reference to FIG. 12.

FIG. 12 is a schematic diagram of a combined cycle power plant, e.g., system 300, comprising GTE 202 operating in simple cycle with absorption chiller 308E, wherein at least a portion of the exhaust gas of the GTE 202 can be routed through absorption chiller 308E.

Absorption chiller 308E can be configured similarly to absorption chiller 102 of FIG. 1 and can operate in conjunction with a heat exchanger or cooling tower as described with reference to FIG. 1. In examples, all exhaust gas from GTE 202 is directed to absorption chiller 308E, which can be driven by flue gas. In the illustrated example, there can be no heat recovery unit or steam generator, nor any community heat users. Because no heat recovery unit or steam generator is present in the embodiment of FIG. 12, absorption chiller 308E can be configured for direct flue gas service, comprising a gas-side heat exchanger disposed within or associated with absorption chiller 308E that transfers thermal energy from the exhaust gas stream directly to the working fluid to drive the generation cycle of the absorption chiller. The remainder of the absorption cycle, including the evaporator-absorber section and the cooling water loop, can operate in a manner consistent with the description of absorption chiller 102 of FIG. 1. The exhaust gas can exit absorption chiller 308E at a reduced temperature and can be directed to stack 232 for venting.

### Example Benefits of the Disclosed Systems

The patent disclosure provides multiple benefits over conventional systems.
1. Efficient Use of Waste Heat: The systems of the present disclosure utilize low-grade heat recovered from the gas turbine exhaust to drive absorption chillers, providing thermodynamically efficient and cost-effective cooling for both gas turbine inlet air and data centers.
2. Operational Flexibility: The combined heat and power (CHP) systems of the present disclosure are designed with flexibility to provide cooling and/or heating depending on weather conditions, maximizing equipment utilization year-round.
3. Storage Capabilities: The chilled water storage unit of the present disclosure provides additional operational flexibility in meeting daily and weekly cooling demand fluctuations.
4. Free Cooling Advantage: The ambient cooling unit of the present disclosure takes advantage of free cooling by cold ambient air, further increasing the system's energy efficiency.
5. Emissions Control Compatibility: The CHP systems of the present disclosure can easily accommodate state-of-the-art CO and NOx control equipment.
6. Low Carbon Footprint: The systems of the present disclosure are highly energy efficient with a low carbon footprint. They can cool the gas turbine exhaust to as low as 200 °F (~93.3 °C), which is conducive to adding a post-combustion carbon capture unit that can remove approximately 95% of the CO2 in the exhaust.
7. Multiple Revenue Streams: The CHP systems of the present disclosure can generate and supply electricity, chilled water, and hot water/steam simultaneously, greatly improving year-round energy efficiency and opening up opportunities for economical operation with multiple revenue streams.
8. Potential for Government Incentives: The highly efficient combined heat and power systems of the present disclosure potentially qualify for various federal, state, and local government energy incentives, including federal investment tax credits (ITC). Plants with the proposed CHP system would be eligible as a Qualifying Facility (QF) under the Public Utility Regulatory Policies Act (PURPA) of 1978.

### EXAMPLES

Example 1 is a power production facility comprising: a gas turbine engine configured to combust a mixture of an inlet air and a fuel to produce exhaust gas; an electrical generator configured to be driven by the gas turbine engine; an absorption chiller configured to receive a heat input generated by the gas turbine engine to generate a chilled fluid; an inlet air chiller configured to receive the chilled fluid from the absorption chiller for cooling the inlet air before entering the gas turbine engine; and a data center configured to receive the chilled fluid from the absorption chiller.

In Example 2, the subject matter of Example 1 optionally includes wherein the inlet air chiller is in serial fluid communication with the absorption chiller and a data center cooling unit comprising a heat exchanger configured to extract heat from the data center, the inlet air chiller disposed upstream of the heat exchanger.

In Example 3, the subject matter of Example 2 optionally includes wherein the heat input generated by the gas turbine engine comprises at least one of the exhaust gas and a fluid heated by the exhaust gas.

In Example 4, the subject matter of Example 3 optionally includes wherein the heat input comprises only exhaust gas and the absorption chiller receives all flow of the exhaust gas from the gas turbine engine and an exhaust stack receives the exhaust gas from the absorption chiller.

In Example 5, the subject matter of any one or more of Examples 3-4 optionally include wherein the heat input comprises only exhaust gas and the absorption chiller receives a first part of flow of the exhaust gas from the gas turbine engine and a steam generator receives a second part of flow of the exhaust gas from the gas turbine engine to generate steam to drive a steam turbine, wherein the first part and the second part are arranged to flow in parallel.

In Example 6, the subject matter of any one or more of Examples 3-5 optionally include wherein the heat input from the gas turbine engine comprises the fluid and the fluid comprises at least one of hot water and steam generated by the exhaust gas in a heat recovery unit.

In Example 7, the subject matter of Example 6 optionally includes a steam turbine configured to be driven by steam generated by the exhaust gas in the heat recovery unit.

In Example 8, the subject matter of Example 7 optionally includes a condenser configured to condense steam from the steam turbine.

In Example 9, the subject matter of any one or more of Examples 7-8 optionally include a heat exchanger configured to remove heat from the absorption chiller.

In Example 10, the subject matter of any one or more of Examples 7-9 optionally include wherein the steam turbine is configured to receive steam directly from the heat recovery unit.

In Example 11, the subject matter of Example 10 optionally includes wherein steam is split between the steam turbine and the absorption chiller.

In Example 12, the subject matter of Example 11 optionally includes wherein steam for the absorption chiller is drawn from the heat recovery unit.

In Example 13, the subject matter of any one or more of Examples 11-12 optionally include wherein steam for the absorption chiller is drawn from the steam turbine.

In Example 14, the subject matter of any one or more of Examples 11-13 optionally include wherein water for the absorption chiller is received from the steam turbine.

In Example 15, the subject matter of any one or more of Examples 6-14 optionally include an external heat consumer.

In Example 16, the subject matter of Example 15 optionally includes wherein the external heat consumer comprises one or more of residential housing units and a community greenhouse.

In Example 17, the subject matter of any one or more of Examples 15-16 optionally include wherein the at least one of hot water and steam generated by the heat recovery unit is alternately routed through the absorption chiller and the external heat consumer.

In Example 18, the subject matter of Example 17 optionally includes a first set of valves to selectively isolate the external heat consumer.

In Example 19, the subject matter of any one or more of Examples 3-18 optionally include a chilled fluid storage device to store the chilled fluid from the absorption chiller before cooling the data center.

In Example 20, the subject matter of Example 19 optionally includes a second set of valves to selectively isolate the chilled fluid storage device.

In Example 21, the subject matter of any one or more of Examples 3-20 optionally include an ambient cooling unit configured to discharge heat from the chilled fluid after cooling the data center.

In Example 22, the subject matter of Example 21 optionally includes a third set of valves to selectively isolate the ambient cooling unit.

In Example 23, the subject matter of any one or more of Examples 6-22 optionally include an external chilled water user configured to receive the chilled fluid from the absorption chiller after having passed through the data center.

In Example 24, the subject matter of any one or more of Examples 1-23 optionally include a controller configured to operate the power production facility differently for different weather conditions.

In Example 25, the subject matter of Example 24 optionally includes wherein the controller is configured to: provide steam from a steam generator to the absorption chiller in hot weather operations; and provide chilled fluid from the absorption chiller to the data center and an inlet air chiller for the gas turbine engine, and not provide the chilled fluid to an ambient cooling unit in the hot weather operations.

In Example 26, the subject matter of any one or more of Examples 24-25 optionally include wherein the controller is configured to: provide steam from a steam generator to community heat users in cold weather operations; and circulate chilled fluid between the data center and an ambient cooling unit in cold weather operations.

In Example 27, the subject matter of any one or more of Examples 24-26 optionally include wherein the controller is configured to: provide steam from a steam generator to the absorption chiller and community heat users in mild weather operations; and provide chilled fluid from the absorption chiller to the data center and an ambient cooling unit, and not provide the chilled fluid to an inlet air chiller in the mild weather operations.

Example 28 is a method of operating a power production facility, the method comprising: combusting a mixture of an inlet air and a fuel in a gas turbine engine to produce exhaust gas; driving an electrical generator with the gas turbine engine; providing a heat input generated by the gas turbine engine to an absorption chiller to generate a chilled fluid; cooling the inlet air before entering the gas turbine engine using the chilled fluid from the absorption chiller; and cooling a data center with the chilled fluid from the absorption chiller.

In Example 29, the subject matter of Example 28 optionally includes wherein the inlet air is cooled in an inlet air chiller that is in serial fluid communication with the absorption chiller and a heat exchanger configured to extract heat from the data center, the inlet air chiller disposed upstream of the heat exchanger.

In Example 30, the subject matter of any one or more of Examples 28-29 optionally include wherein the heat input from the gas turbine engine comprises at least one of the exhaust gas and a fluid heated by the exhaust gas.

In Example 31, the subject matter of Example 30 optionally includes wherein providing the heat input comprises directing all flow of the exhaust gas from the gas turbine engine to the absorption chiller and directing the exhaust gas from the absorption chiller to an exhaust stack.

In Example 32, the subject matter of any one or more of Examples 30-31 optionally include wherein providing the heat input comprises: directing a first part of flow of the exhaust gas from the gas turbine engine to the absorption chiller; and directing a second part of flow of the exhaust gas from the gas turbine engine to a steam generator to generate steam to drive a steam turbine.

In Example 33, the subject matter of any one or more of Examples 30-32 optionally include wherein the heat input from the gas turbine engine comprises the fluid and the fluid comprises at least one of hot water and steam generated by the exhaust gas in a heat recovery unit.

In Example 34, the subject matter of Example 33 optionally includes driving a steam turbine with steam generated by the exhaust gas in the heat recovery unit.

In Example 35, the subject matter of Example 34 optionally includes condensing steam from the steam turbine in a condenser.

In Example 36, the subject matter of any one or more of Examples 34-35 optionally include removing heat from the absorption chiller using a heat exchanger.

In Example 37, the subject matter of any one or more of Examples 34-36 optionally include wherein the steam turbine receives steam directly from the heat recovery unit.

In Example 38, the subject matter of Example 37 optionally includes splitting steam between the steam turbine and the absorption chiller.

In Example 39, the subject matter of Example 38 optionally includes wherein steam for the absorption chiller is drawn from the heat recovery unit.

In Example 40, the subject matter of any one or more of Examples 38-39 optionally include wherein steam for the absorption chiller is drawn from the steam turbine.

In Example 41, the subject matter of any one or more of Examples 33-40 optionally include providing heat to an external heat consumer.

In Example 42, the subject matter of Example 41 optionally includes wherein the external heat consumer comprises one or more of residential housing units and a community greenhouse.

In Example 43, the subject matter of any one or more of Examples 41-42 optionally include selectively routing the at least one of hot water and steam generated by the heat recovery unit through the absorption chiller or the external heat consumer.

In Example 44, the subject matter of Example 43 optionally includes selectively isolating the external heat consumer using a first set of valves.

In Example 45, the subject matter of any one or more of Examples 30-44 optionally include storing the chilled fluid from the absorption chiller in a chilled fluid storage device before cooling the data center.

In Example 46, the subject matter of Example 45 optionally includes selectively isolating the chilled fluid storage device using a second set of valves.

In Example 47, the subject matter of any one or more of Examples 30-46 optionally include discharging heat from the chilled fluid after cooling the data center using an ambient cooling unit.

In Example 48, the subject matter of Example 47 optionally includes selectively isolating the ambient cooling unit using a third set of valves.

In Example 49, the subject matter of any one or more of Examples 33-48 optionally include providing the chilled fluid from the absorption chiller to an external chilled water user downstream of the data center.

In Example 50, the subject matter of any one or more of Examples 28-49 optionally include operating the power production facility differently for different weather conditions.

In Example 51, the subject matter of Example 50 optionally includes wherein operating the power production facility differently comprises: providing steam from a steam generator to the absorption chiller in hot weather operations; and providing chilled fluid from the absorption chiller to the data center and an inlet air chiller for the gas turbine engine, and not providing the chilled fluid to an ambient cooling unit in the hot weather operations.

In Example 52, the subject matter of any one or more of Examples 50-51 optionally include wherein operating the power production facility differently comprises: providing steam from a steam generator to community heat users in cold weather operations; and circulating chilled fluid between the data center and an ambient cooling unit in cold weather operations.

In Example 53, the subject matter of any one or more of Examples 50-52 optionally include wherein operating the power production facility differently comprises: providing steam from a steam generator to the absorption chiller and community heat users in mild weather operations; and providing chilled fluid from the absorption chiller to the data center and an ambient cooling unit, and not providing the chilled fluid to an inlet air chiller in the mild weather operations.

Each of these non-limiting examples can stand on its own, or can be combined in various permutations or combinations with one or more of the other examples.

### Various Notes

The above detailed description includes references to the accompanying drawings, which form a part of the detailed description. The drawings show, by way of illustration, specific embodiments in which the invention can be practiced. These embodiments can be referred to as “examples.” Such examples can include elements in addition to those shown or described. The present disclosure can include examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” In the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical constraints on their objects.

The term “about,” as used herein, means approximately, in the region of, roughly, or around. When the term “about” or “approximately” is used in conjunction with a numerical range, it modifies that range by extending the boundaries above and below the numerical values set forth. The term “about” or “approximately” is used herein to modify a numerical value above and below the stated value by a variance of 10%. In one aspect, the term “about” or “approximately” means plus or minus 10% of the numerical value of the number with which it is being used. Therefore, “about 50%” or “approximately 50%” means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1 4, and 2-4). It is to be understood that all numbers and fractions thereof are presumed to be modified by the term “about” or “approximately.”

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. The following claims are hereby incorporated into the Detailed Description as examples or embodiments, with each claim standing on its own as a separate embodiment, and it is understood that such embodiments can be combined with each other in various combinations or permutations. The scope of the invention should be determined with reference to the appended claims, along with the full scope of equivalents to which such claims are entitled.

The claimed invention is:

1. A power production facility comprising:
a gas turbine engine configured to combust a mixture of an inlet air and a fuel to produce exhaust gas;
an electrical generator configured to be driven by the gas turbine engine;
an absorption chiller configured to receive a heat input generated by the gas turbine engine to generate a chilled fluid;
an inlet air chiller configured to receive the chilled fluid from the absorption chiller for cooling the inlet air before entering the gas turbine engine; and
a data center configured to receive the chilled fluid from the absorption chiller.

2. The power production facility of claim 1, wherein the inlet air chiller is in serial fluid communication with the absorption chiller and a data center cooling unit comprising a heat exchanger configured to extract heat from the data center, the inlet air chiller disposed upstream of the heat exchanger.

3. The power production facility of claim 2, wherein the heat input generated by the gas turbine engine comprises at least one of the exhaust gas and a fluid heated by the exhaust gas.

4. The power production facility of claim 3, wherein the heat input comprises exhaust gas and the absorption chiller receives all flow of the exhaust gas from the gas turbine engine and an exhaust stack receives the exhaust gas from the absorption chiller.

5. The power production facility of claim 3, wherein the heat input comprises exhaust gas and the absorption chiller receives a first part of flow of the exhaust gas from the gas turbine engine and a steam generator receives a second part of flow of the exhaust gas from the gas turbine engine to generate steam to drive a steam turbine, wherein the first part and the second part are arranged to flow in parallel.

6. The power production facility of claim 3, wherein the heat input comprises the fluid, the fluid comprises at least one of hot water and steam generated by the exhaust gas in a heat recovery unit, and the power production facility further comprises a steam turbine configured to be driven by the steam generated by the exhaust gas in the heat recovery unit and a condenser configured to condense steam from the steam turbine.

7. The power production facility of claim 6, wherein steam is split between the steam turbine and the absorption chiller, and wherein the steam for the absorption chiller is drawn from one of the heat recovery unit and the steam turbine.

8. The power production facility of claim 6, further comprising an external heat consumer, wherein the at least one of hot water and steam generated by the heat recovery unit is alternately routed through the absorption chiller and the external heat consumer via a first set of valves configured to selectively isolate the external heat consumer.

9. The power production facility of claim 6, further comprising an external chilled water user configured to receive the chilled fluid from the absorption chiller after having passed through the data center.

19. The power production facility of claim 3, further comprising: a chilled fluid storage device configured to store the chilled fluid from the absorption chiller before cooling the data center, and a second set of valves configured to selectively isolate the chilled fluid storage device; and an ambient cooling unit configured to discharge heat from the chilled fluid after cooling the data center, and a third set of valves configured to selectively isolate the ambient cooling unit.

11. The power production facility of claim 1, further comprising a controller configured to operate the power production facility differently for different weather conditions, wherein the controller is configured to:
provide steam from a steam generator to the absorption chiller and provide chilled fluid from the absorption chiller to the data center and the inlet air chiller, without providing the chilled fluid to an ambient cooling unit, in hot weather operations;
provide steam from the steam generator to community heat users and circulate chilled fluid between the data center and an ambient cooling unit, without operating the absorption chiller or the inlet air chiller, in cold weather operations; and
provide steam from the steam generator to both the absorption chiller and community heat users and provide chilled fluid from the absorption chiller to the data center and an ambient cooling unit, without providing the chilled fluid to the inlet air chiller, in mild weather operations.

12. A method of operating a power production facility, the method comprising:
combusting a mixture of an inlet air and a fuel in a gas turbine engine to produce exhaust gas;
driving an electrical generator with the gas turbine engine;
providing a heat input generated by the gas turbine engine to an absorption chiller to generate a chilled fluid;
cooling the inlet air before entering the gas turbine engine using the chilled fluid from the absorption chiller; and
cooling a data center with the chilled fluid from the absorption chiller.

13. The method of claim 12, wherein the heat input from the gas turbine engine comprises at least one of the exhaust gas and a fluid heated by the exhaust gas, and wherein providing the heat input comprises one of: directing all flow of the exhaust gas from the gas turbine engine to the absorption chiller and directing the exhaust gas from the absorption chiller to an exhaust stack;
directing a first part of flow of the exhaust gas to the absorption chiller and directing a second part of flow of the exhaust gas to a steam generator to generate steam to drive a steam turbine; or generating at least one of hot water and steam from the exhaust gas in a heat recovery unit and directing the at least one of hot water and steam to the absorption chiller.

14. The method of claim 13, further comprising driving a steam turbine with steam generated by the exhaust gas in a heat recovery unit and splitting steam between the steam turbine and the absorption chiller, wherein the steam for the absorption chiller is drawn from one of the heat recovery unit and the steam turbine.

15. The method of claim 13, further comprising:
selectively routing the at least one of hot water and steam through the absorption chiller or an external heat consumer using a first set of valves; and
providing the chilled fluid from the absorption chiller to an external chilled water user downstream of the data center.

16. The method of claim 13, further comprising:
storing the chilled fluid in a chilled fluid storage device before cooling the data center, and selectively isolating the chilled fluid storage device using a second set of valves; and
discharging heat from the chilled fluid after cooling the data center using an ambient cooling unit, and selectively isolating the ambient cooling unit using a third set of valves.

17. The method of claim 12, wherein the inlet air is cooled in an inlet air chiller that is in serial fluid communication with the absorption chiller and a heat exchanger configured to extract heat from the data center, the inlet air chiller disposed upstream of the heat exchanger.

18. The method of claim 17, further comprising operating the power production facility differently for different weather conditions, wherein operating differently comprises:
providing steam from a steam generator to the absorption chiller and providing chilled fluid from the absorption chiller to the data center and the inlet air chiller, without providing the chilled fluid to an ambient cooling unit, in hot weather operations; and
providing steam from the steam generator to community heat users and circulating chilled fluid between the data center and an ambient cooling unit, without operating the absorption chiller or the inlet air chiller, in cold weather operations.

19. The method of claim 18, wherein operating differently further comprises: providing steam from the steam generator to both the absorption chiller and community heat users in mild weather operations; and providing chilled fluid from the absorption chiller to the data center and an ambient cooling unit, without providing the chilled fluid to the inlet air chiller, in the mild weather operations.

20. A controller for operating a power production facility, the power production facility comprising a gas turbine engine configured to combust a mixture of an inlet air and a fuel to produce exhaust gas, an electrical generator configured to be driven by the gas turbine engine, an absorption chiller configured to receive a heat input generated by the gas turbine engine to generate a chilled fluid, an inlet air chiller configured to receive the chilled fluid from the absorption chiller for cooling the inlet air before entering the gas turbine engine, and a data center configured to receive the chilled fluid from the absorption chiller, the controller comprising:
one or more processors; and
a non-transitory computer-readable storage medium storing instructions that, when executed by the one or more processors, cause the controller to:
provide a heat input generated by the gas turbine engine to the absorption chiller to generate a chilled fluid;
cool the inlet air before entering the gas turbine engine using the chilled fluid from the absorption chiller; and
cool the data center with the chilled fluid from the absorption chiller.
